(19) United States
(12) Patent Application Publication
(10) Pub. No.: US 2020/0212817 A1
(43) Pub. Date: Jul. 2, 2020

(54) ON-BOARD CHARGING/DISCHARGING SYSTEM

(71) Applicant: Delta Electronics (Shanghai) Co., Ltd., Shanghai (CN)

(72) Inventors: Hao Sun, Shanghai (CN); Minli Jia, Shanghai (CN); Jinfa Zhang, Shanghai (CN)

(21) Appl. No.: 16/667,284

(22) Filed: Oct. 29, 2019

(30) Foreign Application Priority Data
Dec. 27, 2018 (CN) 201811609651.5

(51) Int. Cl. H02M 3/335; H02M 1/42; H02J 7/02; H02M 1/08; B60L 53/22; B60L 50/64

(52) U.S. Cl. CPC H02M 3/33584; H02M 1/4208; H02J 7/022; B60L 2210/10; H02M 3/33592; B60L 53/22; B60L 50/64; H02M 1/083

(57) ABSTRACT

An on-board charging/discharging system includes a bidirectional converter and a low-voltage DC/DC converter. The bidirectional converter is electrically connected between an external device and a high-voltage battery. The bidirectional converter includes a power factor correction circuit, a bus capacitor and a bidirectional DC/DC conversion circuit. A first terminal of the power factor correction circuit is electrically connected with the external device. The bus capacitor is electrically connected with a second terminal of the power factor correction circuit. The bidirectional DC/DC conversion circuit is electrically connected between the bus capacitor and the high-voltage battery. The low-voltage DC/DC converter is electrically connected between the bus capacitor and a low-voltage battery. The low-voltage DC/DC converter includes at least one main switch. When the low-voltage DC/DC converter is enabled, a bus voltage of the bus capacitor is converted into a regulated voltage to power the low-voltage battery.

### FIELD OF THE INVENTION

The present disclosure relates to a field of an electric vehicle, and more particularly to an on-board charging/discharging system.

### BACKGROUND OF THE INVENTION

Generally, the electric vehicle includes an on-board charging/discharging system. The on-board charging/discharging system is used for converting the input AC energy into regulated DC voltages. The regulated DC voltages are provided to the high-voltage battery and the low-voltage battery in the electric vehicle. According to the power supply requirements of the high-voltage battery and the low-voltage battery, the conventional on-board charging/discharging system usually includes a unidirectional on-board charger and a low-voltage DC/DC converter. After the input AC energy is received by the on-board charging/discharging system, the input AC energy is converted into a high DC voltage by the on-board charger. The high DC voltage is provided to the high-voltage battery. The low-voltage DC/DC converter is electrically connected with the high-voltage battery. By the low-voltage DC/DC converter, the high DC voltage from the high-voltage battery is converted into a low DC voltage. The low DC voltage is provided to the low-voltage battery.

However, the conventional on-board charging/discharging system still has some drawbacks. For example, since the voltage range of the high-voltage battery is wide, the low-voltage DC/DC converter of the conventional on-board charging/discharging system cannot use the resonant circuitry topology. In other words, the switches of the low-voltage DC/DC converter cannot achieve the zero-voltage switching. Under this circumstance, it is difficult to optimize the volume and the efficiency of the conventional on-board charging/discharging system. For solving the above problems, another conventional on-board charging/discharging system is additionally equipped with a voltage regulator electrically connected with the input terminal of the low-voltage DC/DC converter. By the voltage regulator, the voltage range of the high-voltage battery is narrowed and the resonant circuitry topology is applicable to the low-voltage DC/DC converter. As known, the additional voltage regulator increases the fabricating cost and the control complexity of the conventional on-board charging/discharging system.

Therefore, there is a need of providing an improved on-board charging/discharging system in order to overcome the drawbacks of the conventional technologies.

### SUMMARY OF THE INVENTION

An object of the present disclosure provides an on-board charging/discharging system to address the issues encountered by the prior arts as follows. In some prior arts, the low-voltage DC/DC converter of the conventional on-board charging/discharging system cannot use the resonant circuitry topology, so that it is difficult to optimize the volume and the efficiency of the conventional on-board charging/discharging system. In some other prior arts, the conventional on-board charging/discharging system is additionally equipped with a voltage regulator electrically connected with the input terminal of the low-voltage DC/DC converter so that the resonant circuitry topology is applicable to the low-voltage DC/DC converter. However, the additional voltage regulator increases the fabricating cost and the control complexity of the conventional on-board charging/discharging system.

A further object of the present disclosure provides an on-board charging/discharging system with optimized volume, enhanced efficiency, reduced fabricating cost and reduced control complexity.

In accordance with an aspect of the present disclosure, a on-board charging/discharging system is provided. The on-board charging/discharging system includes a bidirectional converter and a low-voltage DC/DC converter. The bidirectional converter is electrically connected between an external device and a high-voltage battery. The bidirectional converter includes a power factor correction circuit, a bus capacitor and a bidirectional DC/DC conversion circuit. A first terminal of the power factor correction circuit is electrically connected with the external device and is configured to convert received or outputted electric energy. The bus capacitor is electrically connected with a second terminal of the power factor correction circuit. The bidirectional DC/DC conversion circuit is electrically connected between the bus capacitor and the high-voltage battery and is configured to convert electric energy in two directions so as to charge or discharge the high-voltage battery. The low-voltage DC/DC converter is electrically connected between the bus capacitor and a low-voltage battery. The low-voltage DC/DC converter includes a resonant circuit and at least one main switch. The low-voltage DC/DC converter achieves zero-voltage switching of the at least one main switch through a resonant tank of the resonant circuit. When the low-voltage DC/DC converter is enabled, an energy of the bus capacitor is converted into a regulated voltage to power the low-voltage battery.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating the architecture of an on-board charging/discharging system according to an embodiment of the present disclosure;

FIG. 2 is a schematic circuit diagram illustrating the path of transferring the electric energy when the on-board charging/discharging system is in a first mode;

FIG. 3 is a schematic circuit diagram illustrating the path of transferring the electric energy when the on-board charging/discharging system is in a second mode;

FIG. 4 is a schematic circuit diagram illustrating the path of transferring the electric energy when the on-board charging/discharging system is in a third mode;

FIG. 5 is a schematic circuit diagram illustrating the path of transferring the electric energy when the on-board charging/discharging system is in a fourth mode; and

FIG. 6 is a schematic circuit diagram illustrating the path of transferring the electric energy when the on-board charging/discharging system is in a fifth mode.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

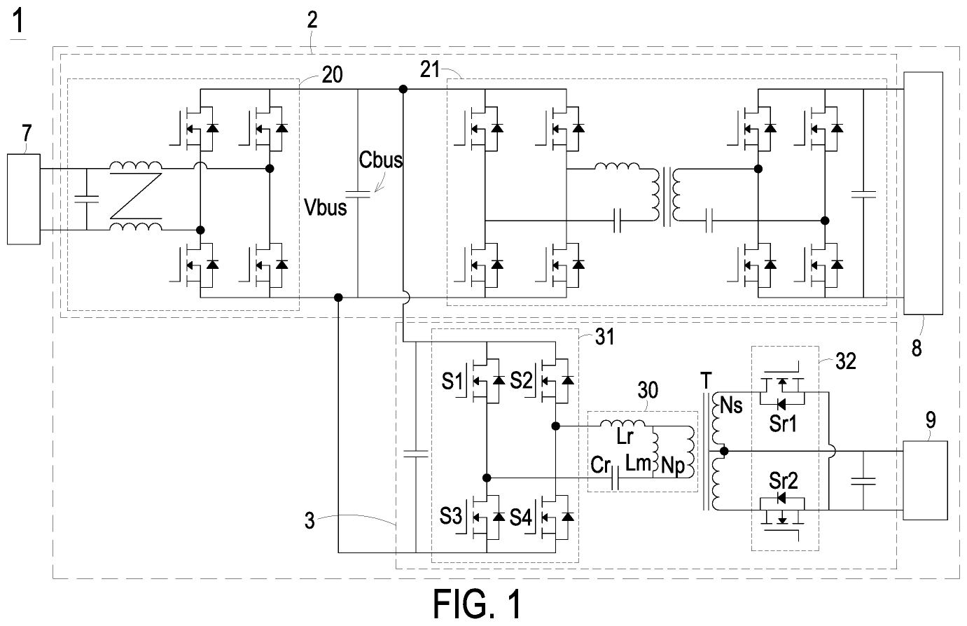

FIG. 1 is a schematic circuit diagram illustrating the architecture of an on-board charging/discharging system according to an embodiment of the present disclosure. As shown in FIG. 1, preferably but not exclusively, the on-board charging/discharging system 1 is applied to an electric vehicle. The on-board charging/discharging system 1 is separably electrically connected with at least one external device 7. The external device 7 is not limited a single equipment, and the example of the external device 7 may be varied according to the practical requirements of the electric vehicle.

In an embodiment, the on-board charging/discharging system 1 includes a high-voltage battery 8 and a low-voltage battery 9. The high-voltage battery 8 provides electric energy for driving the electric vehicle. The low-voltage battery 9 is installed within the electric vehicle and drives a plurality of electronic components by low voltages. Moreover, the on-board charging/discharging system 1 is powered by the external device 7. After the electric energy from the external device 7 is converted by the on-board charging/discharging system 1, the regulated voltages are provided to the high-voltage battery 8 and/or the low-voltage battery 9. Alternatively, the on-board charging/discharging system 1 is powered by the high-voltage battery 8. After the electric energy from the high-voltage battery 8 is converted by the on-board charging/discharging system 1, the converted voltage is transmitted to the external device 7 and/or the low-voltage battery 9.

In an embodiment, the on-board charging/discharging system 1 includes a bidirectional converter 2 and a low-voltage DC/DC converter 3. Preferably but not exclusively, the maximum output power of the bidirectional converter 2 is 6.6 KW. The bidirectional converter 2 is electrically connected between the external device 7 and the high-voltage battery 8 of the electric vehicle and configured to convert electric energy in two directions. In addition, the bidirectional converter 2 includes a power factor correction circuit 20, a bus capacitor Cbus and a bidirectional DC/DC conversion circuit 21. A first terminal of the power factor correction circuit 20 is electrically connected with the external device 7. A second terminal of the power factor correction circuit 20 is electrically connected with the bus capacitor Cbus. The power factor correction circuit 20 has the function of correcting the power factor and converting the received electric energy. The bus capacitor Cbus is used for stabilizing voltages. The bidirectional DC/DC conversion circuit 21 is electrically connected with the bus capacitor Cbus. Moreover, the bidirectional DC/DC conversion circuit 21 is electrically connected between the second terminal of the power factor correction circuit 20 and the high-voltage battery 8. The bidirectional DC/DC conversion circuit 21 is capable of converting electric energy in two directions. Consequently, the high-voltage battery 8 is charged or discharged by the bidirectional DC/DC conversion circuit 21.

The low-voltage DC/DC converter 3 is electrically connected between the bus capacitor Cbus and the low-voltage battery 9. The low-voltage DC/DC converter 3 includes a resonant circuit 30 and at least one main switch. The low-voltage DC/DC converter 3 achieves zero-voltage switching of the at least one main switch through a resonant tank of the resonant circuit 30. During the operation of the low-voltage DC/DC converter 3, the bus voltage Vbus of the bus capacitor Cbus is converted into the regulated voltage to power the low-voltage battery 9.

In an embodiment, the low-voltage DC/DC converter 3 further includes a bridge circuit 31, a transformer T and a synchronous rectifying circuit 32. The input terminal of the bridge circuit 31 is electrically connected with the bus capacitor Cbus to receive the energy from the bus capacitor Cbus. The bridge circuit 31 includes four main switches S1, S2, S3 and S4. The resonant circuit 30 is electrically connected between the output terminal of the bridge circuit 31 and a primary winding Np of the transformer T. The resonant circuit 30 includes a resonant inductor Lr, a resonant capacitor Cr and a magnetizing inductor Lm. A resonant tank is defined by the resonant inductor Lr, the resonant capacitor Cr and the magnetizing inductor Lm collaboratively. The synchronous rectifying circuit 32 is electrically connected between a secondary winding Ns of the transformer T and the low-voltage battery 9. The synchronous rectifying circuit 32 includes two synchronous rectifying switches Sr1 and Sr2. The synchronous rectifying circuit 32 performs a synchronous rectifying operation through the two synchronous rectifying switches Sr1 and Sr2. The low-voltage DC/DC converter 3 achieves zero-voltage switching of the four main switches S1, S2, S3 and S4 through the resonant tank of the resonant circuit 30.

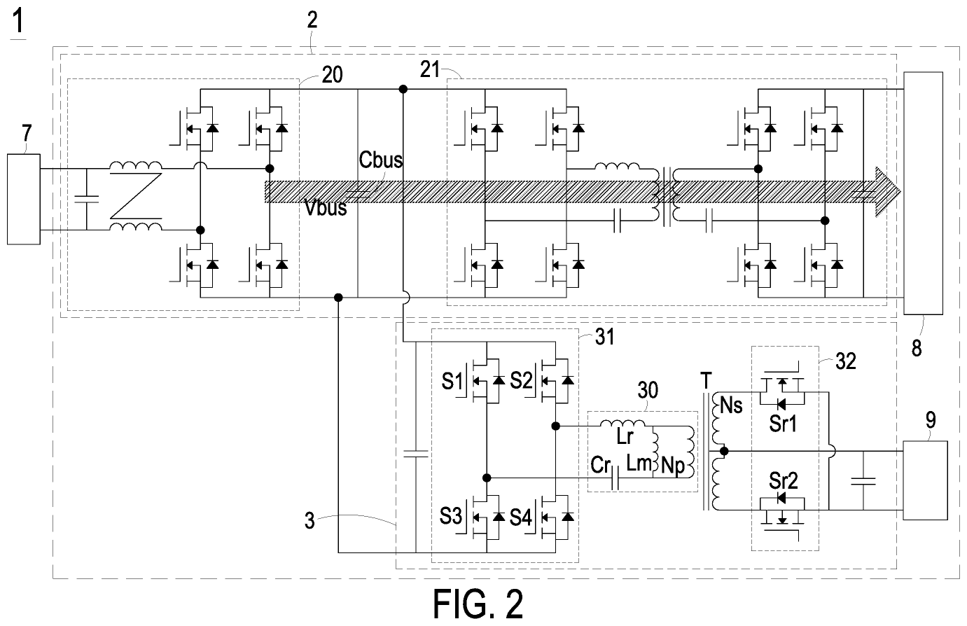

The on-board charging/discharging system 1 is operated in one of five modes. In the five modes, the electric energy is transferred along the arrow directions as shown in FIGS. 2 to 6.

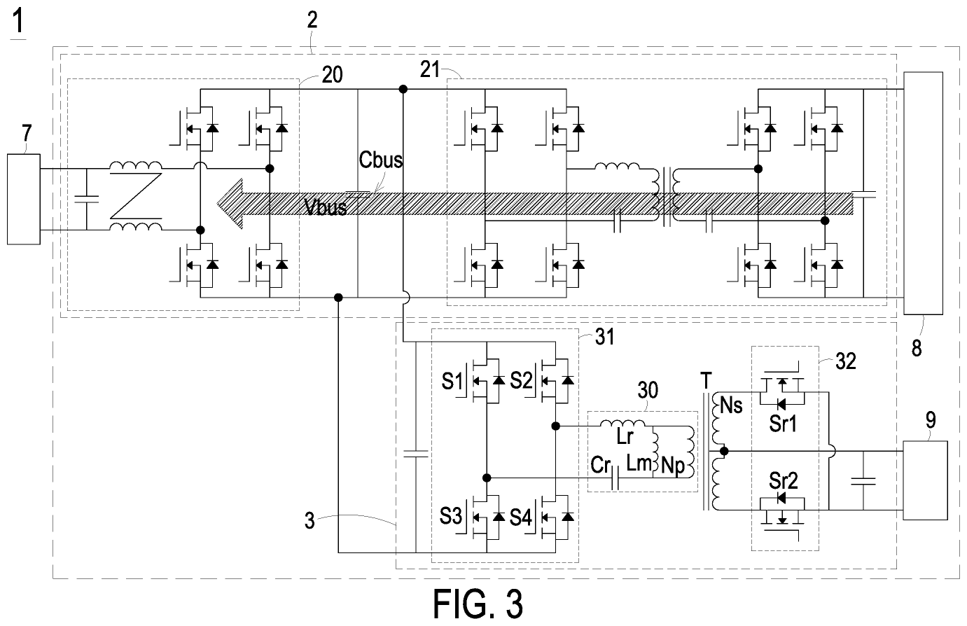

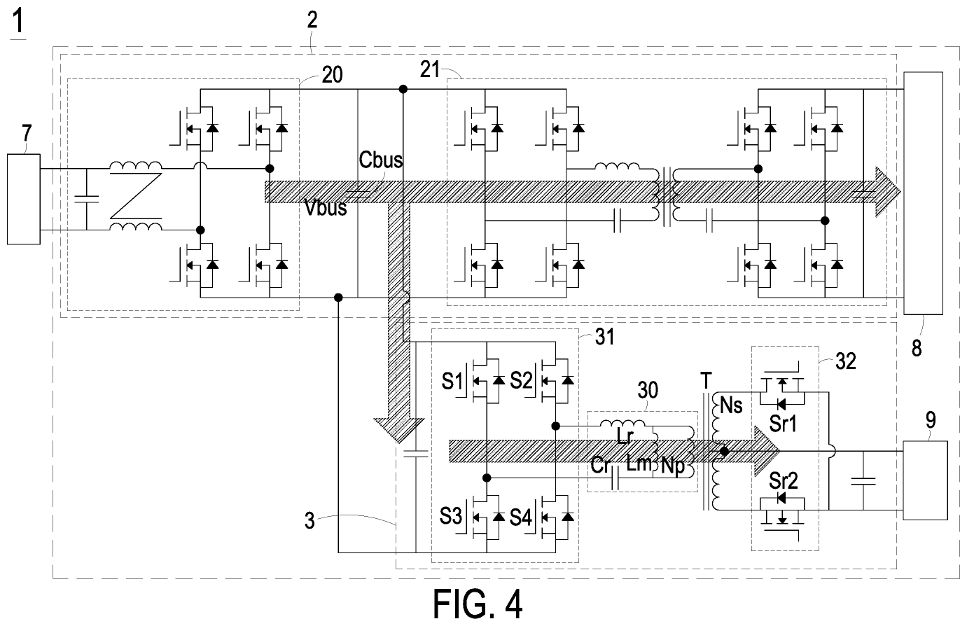

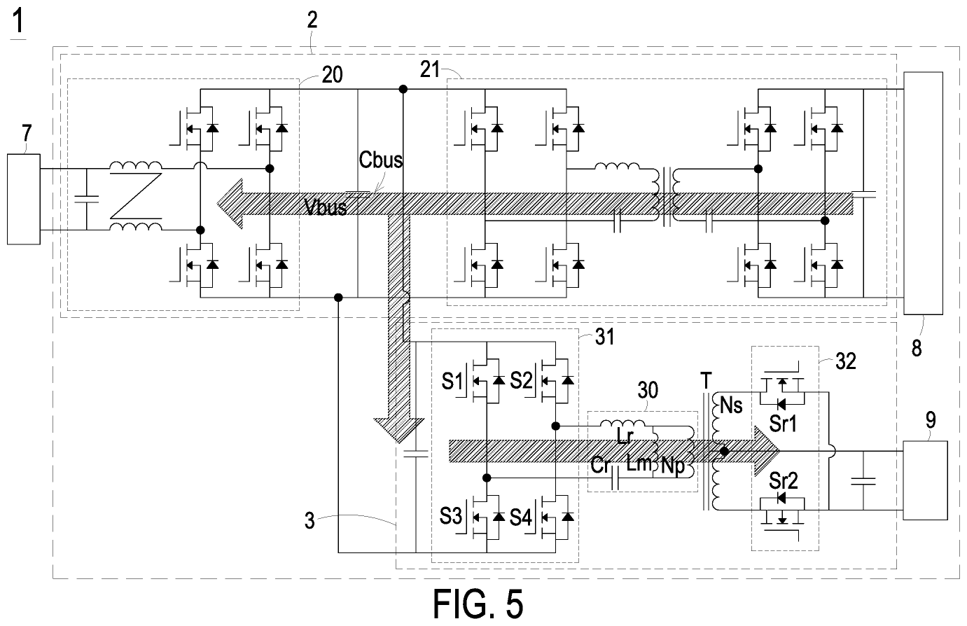

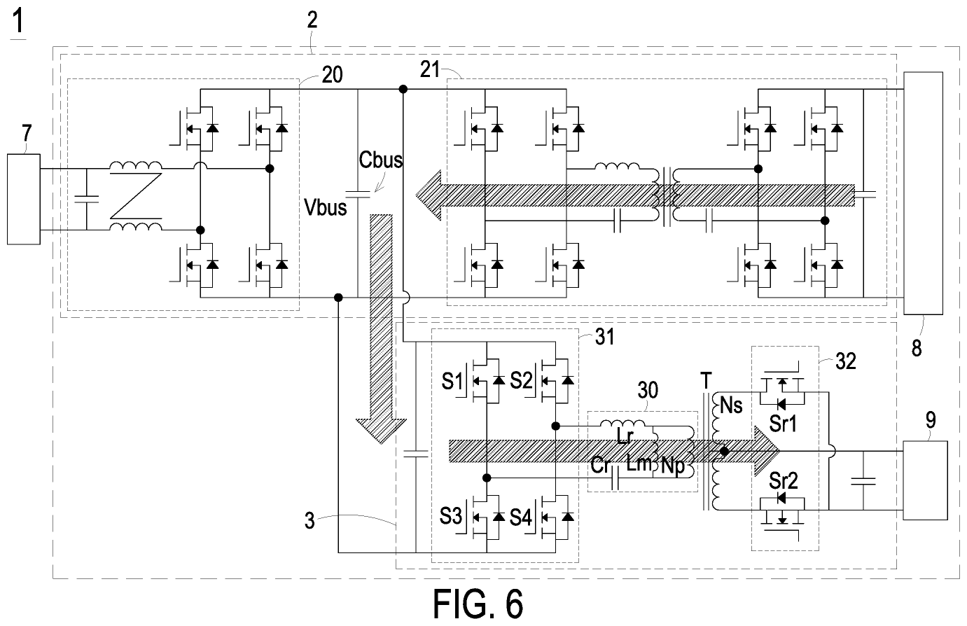

FIG. 2 is a schematic circuit diagram illustrating the path of transferring the electric energy when the on-board charging/discharging system is in a first mode. FIG. 3 is a schematic circuit diagram illustrating the path of transferring the electric energy when the on-board charging/discharging system is in a second mode. FIG. 4 is a schematic circuit diagram illustrating the path of transferring the electric energy when the on-board charging/discharging system is in a third mode. FIG. 5 is a schematic circuit diagram illustrating the path of transferring the electric energy when the on-board charging/discharging system is in a fourth mode. FIG. 6 is a schematic circuit diagram illustrating the path of transferring the electric energy when the on-board charging/discharging system is in a fifth mode.

Please refer to FIG. 2. The on-board charging/discharging system 1 is in the first mode. After the electric energy from the external device 7 is converted by the power factor correction circuit 20, the converted voltage is provided to the bus capacitor Cbus. Consequently, the voltage across the bus capacitor Cbus is the bus voltage Vbus. By the bidirectional DC/DC conversion circuit 21, the bus voltage Vbus of the bus capacitor Cbus is converted into the regulated voltage to charge the high-voltage battery 8. In the first mode, the low-voltage DC/DC converter 3 is disabled.

Please refer to FIG. 3. The on-board charging/discharging system 1 is in the second mode. In the second mode, the high-voltage battery 8 is discharged. After the electric energy from the high-voltage battery 8 is converted by the bidirectional DC/DC conversion circuit 21, the converted voltage is provided to the bus capacitor Cbus. Consequently, the voltage across the bus capacitor Cbus is the bus voltage Vbus. By the power factor correction circuit 20, the bus voltage Vbus of the bus capacitor Cbus is converted and the converted voltage is provided to the external device 7. In the second mode, the low-voltage DC/DC converter 3 is disabled.

Please refer to FIG. 4. The on-board charging/discharging system 1 is in the third mode. After the electric energy from the external device 7 is converted by the power factor correction circuit 20, the converted voltage is provided to the bus capacitor Cbus. Consequently, the voltage across the bus capacitor Cbus is the bus voltage Vbus. By the bidirectional DC/DC conversion circuit 21, the bus voltage Vbus of the bus capacitor Cbus is converted into the regulated voltage to charge the high-voltage battery 8. In the third mode, the low-voltage DC/DC converter 3 is enabled. During the operation of the low-voltage DC/DC converter 3, the bus voltage Vbus of the bus capacitor Cbus is converted into the regulated voltage to power the low-voltage battery 9. In a preferred embodiment, the output power provided by the external device 7 is 6.6 KW.

Please refer to FIG. 5. The on-board charging/discharging system 1 is in the fourth mode. In the fourth mode, the high-voltage battery 8 is discharged. After the electric energy from the high-voltage battery 8 is converted by the bidirectional DC/DC conversion circuit 21, the converted voltage is provided to the bus capacitor Cbus. Consequently, the voltage across the bus capacitor Cbus is the bus voltage Vbus. By the power factor correction circuit 20, the bus voltage Vbus of the bus capacitor Cbus is converted and the converted voltage is provided to the external device 7. In the fourth mode, the low-voltage DC/DC converter 3 is enabled. During the operation of the low-voltage DC/DC converter 3, the bus voltage Vbus of the bus capacitor Cbus is converted into the regulated voltage to power the low-voltage battery 9. In a preferred embodiment, the output power provided by the high-voltage battery 8 is 6.6 KW.

Please refer to FIG. 6. The on-board charging/discharging system 1 is in the fifth mode. In the fifth mode, the high-voltage battery 8 is discharged. After the electric energy from the high-voltage battery 8 is converted by the bidirectional DC/DC conversion circuit 21, the converted voltage is provided to the bus capacitor Cbus. Consequently, the voltage across the bus capacitor Cbus is the bus voltage Vbus. In the fifth mode, the low-voltage DC/DC converter 3 is enabled. During the operation of the low-voltage DC/DC converter 3, the bus voltage Vbus of the bus capacitor Cbus is converted into the regulated voltage to power the low-voltage battery 9. Moreover, the power factor correction circuit 20 is disabled. The bus voltage Vbus of the bus capacitor Cbus can be regulated by the bidirectional converter 2 to achieve optimized operation state.

In an embodiment, the external device 7 is an AC power source such as a charging station. In case that the external device 7 is the AC power source, the on-board charging/discharging system 1 is selectively operated in the first mode or the third mode. Consequently, the AC power source provides the AC power to charge the high-voltage battery 8. Of course, in case that the external device 7 is the AC power source, the on-board charging/discharging system 1 can be operated in the fifth mode. In another embodiment, the external device 7 is a battery. In case that the external device 7 is the battery, the on-board charging/discharging system 1 is selectively operated in second mode or the fourth mode. Consequently, the external device 7 is charged by the electric energy of the high-voltage battery 8. Of course, in case that the external device 7 is the battery, the on-board charging/discharging system 1 can be operated in the fifth mode. Moreover, when the on-board charging/discharging system 1 is selectively operated in the first mode or the second mode, the bidirectional DC/DC conversion circuit 21 is controlled according to a frequency-variable and phase-shift method, but not limited thereto.

From the above descriptions, the present disclosure provides the on-board charging/discharging system. The bidirectional DC/DC conversion circuit of the bidirectional converter of the on-board charging/discharging system is capable of converting electric energy in two directions. The low-voltage DC/DC converter is also electrically connected with the bus capacitor of the bidirectional converter. When the high-voltage battery is discharged and the low-voltage DC/DC converter is enabled, the electric energy from the high-voltage battery is converted by the bidirectional DC/DC conversion circuit and thus the voltage across the bus capacitor is the bus voltage. Then, the bus voltage is converted into the regulated voltage by the low-voltage DC/DC converter so as to power the low-voltage battery. As mentioned above, the high DC voltage from the high-voltage battery of the conventional on-board charging/discharging system is directly converted into a low DC voltage by the low-voltage DC/DC converter. Since the voltage range of the high-voltage battery is wide, the low-voltage DC/DC converter of the conventional on-board charging/discharging system cannot use the resonant circuitry topology. In accordance with the technology of the present disclosure, the on-board charging/discharging system can use the resonant circuitry topology without the additional voltage regulator. Consequently, the on-board charging/discharging system of the present disclosure has optimized volume and efficiency. In addition, the fabricating cost and the control complexity are reduced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An on-board charging/discharging system, comprising:
a bidirectional converter electrically connected between an external device and a high-voltage battery, and comprising:
a power factor correction circuit, wherein a first terminal of the power factor correction circuit is electrically connected with the external device and the power factor correction circuit is configured to convert received or outputted electric energy;
a bus capacitor electrically connected with a second terminal of the power factor correction circuit; and
a bidirectional DC/DC conversion circuit electrically connected between the bus capacitor and the high-voltage battery and configured to convert electric energy in two directions so as to charge or discharge the high-voltage battery; and
a low-voltage DC/DC converter electrically connected between the bus capacitor and a low-voltage battery, and comprising at least one main switch, wherein when the low-voltage DC/DC converter is enabled, a bus voltage of the bus capacitor is converted into a regulated voltage to power the low-voltage battery.

2. The on-board charging/discharging system according to claim 1, wherein the low-voltage DC/DC converter further comprises a bridge circuit, a transformer and a synchronous rectifying circuit, wherein an input terminal of the bridge circuit is electrically connected with the bus capacitor to receive the energy from the bus capacitor, a primary winding of the transformer is electrically connected with the bridge circuit, and the synchronous rectifying circuit is electrically connected between a secondary winding of the transformer and the low-voltage battery.

3. The on-board charging/discharging system according to claim 1, wherein the power factor correction circuit is a unidirectional power factor correction circuit or a bidirectional power factor correction circuit.

4. The on-board charging/discharging system according to claim 1, wherein the low-voltage DC/DC converter further comprises a resonant circuit, and low-voltage DC/DC converter achieves zero-voltage switching of the at least one main switch through a resonant tank of the resonant circuit.

5. The on-board charging/discharging system according to claim 1, wherein when the on-board charging/discharging system is in a first mode, electric energy from the external device is converted by the power factor correction circuit and provided to the bus capacitor, and the energy of the bus capacitor is converted by the bidirectional DC/DC conversion circuit and provided to the high-voltage battery to charge the high-voltage battery, wherein when the on-board charging/discharging system is in the first mode, the low-voltage DC/DC converter is disabled.

6. The on-board charging/discharging system according to claim 5, wherein the bidirectional DC/DC conversion circuit is controlled according to a frequency-variable and phase-shift method.

7. The on-board charging/discharging system according to claim 1, wherein when the on-board charging/discharging system is in a second mode, the high-voltage battery is discharged, electric energy of the high-voltage battery is converted by the bidirectional DC/DC conversion circuit and provided to the bus capacitor, and the energy of the bus capacitor is converted by the power factor correction circuit and provided to the external device, wherein when the on-board charging/discharging system is in the second mode, the low-voltage DC/DC converter is disabled.

8. The on-board charging/discharging system according to claim 7, wherein the bidirectional DC/DC conversion circuit is controlled according to a frequency-variable and phase-shift method.

9. The on-board charging/discharging system according to claim 1, wherein when the on-board charging/discharging system is in a third mode, electric energy from the external device is converted by the power factor correction circuit and provided to the bus capacitor, and the energy of the bus capacitor is converted by the bidirectional DC/DC conversion circuit and provided to the high-voltage battery to charge the high-voltage battery, wherein when the on-board charging/discharging system is in the third mode, the low-voltage DC/DC converter is enabled, and the bus voltage of the bus capacitor is converted into the regulated voltage by the low-voltage DC/DC converter to power the low-voltage battery.

10. The on-board charging/discharging system according to claim 1, wherein when the on-board charging/discharging system is in a fourth mode, the high-voltage battery is discharged, electric energy of the high-voltage battery is converted by the bidirectional DC/DC conversion circuit and provided to the bus capacitor, and the bus voltage is converted by the power factor correction circuit and provided to the external device, wherein when the on-board charging/discharging system is in the fourth mode, the low-voltage DC/DC converter is enabled, and the bus voltage of the bus capacitor is converted into the regulated voltage by the low-voltage DC/DC converter to power the low-voltage battery.

11. The on-board charging/discharging system according to claim 1, wherein when the on-board charging/discharging system is in a fifth mode, the high-voltage battery is discharged, and electric energy of the high-voltage battery is converted by the bidirectional DC/DC conversion circuit and provided to the bus capacitor, wherein when the on-board charging/discharging system is in the fifth mode, the power factor correction circuit is disabled, the low-voltage DC/DC converter is enabled, and the bus voltage of the bus capacitor is converted into the regulated voltage by the low-voltage DC/DC converter to power the low-voltage battery.
